(19) United States
(12) Patent Application Publication
(10) Pub. No.: US 2023/0385892 A1
(43) Pub. Date: Nov. 30, 2023

(54) NEGOTIATION DEVICE, NEGOTIATION SYSTEM, NEGOTIATION METHOD, AND NEGOTIATION PROGRAM

(71) Applicant: NEC Corporation, Minato ku, Tokyo (JP)

(72) Inventor: Ryota HIGA, Tokyo (JP)

(73) Assignee: NEC Corporation, Minato ku, Tokyo (JP)

(21) Appl. No.: 18/032,404

(22) PCT Filed: Oct. 23, 2020
(86) PCT No.: PCT/JP2020/039820

§ 371 Date: Apr. 18, 2023

(51) Int. Cl. G06Q 30/0601

(52) U.S. Cl. CPC G06Q 30/0611

(57) ABSTRACT

An execution planning means 81 calculates, with an offer from another agent as a constraint condition, a first value which is a value of an optimal execution plan up to achievement of an objective planned based on a state transition by an action taken according to a policy of an own agent. A determination means 82 determines, with the first value as an argument, whether or not a value calculated by a utility function, which is a function defining a utility of an execution plan of the own agent when the offer from the other agent is accepted, is greater than a predetermined threshold value. The determination means 82 determines to accept the offer from the other agent when the value is greater than the threshold value, and determines to reject the offer from the other agent when the value is equal to or less than the threshold value.

### TECHNICAL FIELD

The present invention relates to a negotiation device, a negotiation system, a negotiation method, and a negotiation program configured to perform automatic negotiation between agents.

### BACKGROUND ART

With the development of artificial intelligence (AI) in recent years, research and development of automatic negotiation in which AIs form an agreement based on respective strategies and the like have progressed. The technology of the automatic negotiation is also used for an automatic guided vehicle (AGV), an unmanned aircraft system (USA), and the like in addition to bidding in an auction.

For example, NPL 1 describes a route search method (multi-agent path finding (MAPF)) by a plurality of agents. In the method described in NPL 1, an agent reactively plans a route online in a partially observable world while performing implicit adjustment using a framework of MAPF in which reinforcement learning and mimic learning are combined with each other.

It is noted that NPL 2 describes alternating offers protocol (AOP) which are an example of a protocol configured to perform automatic negotiation.

### CITATION LIST

### Non Patent Literature

NPL 1: Sartoretti G, et al., “PRIMAL: Pathfinding via Reinforcement and Imitation Multi-Agent Learning”, IEEE Robotics and Automation Letters, Institute of Electrical and Electronics Engineers, March 2019.

NPL 2: Reyhan A, et al., “Alternating Offers Protocols for Multilateral Negotiation”, Modern Approaches to Agent-based Complex Automated Negotiation, pp. 153-167, April 2017.

### SUMMARY OF INVENTION

### Technical Problem

On the other hand, in the method described in NPL 1, a situation in which centralized control can be performed is assumed as a premise of performing overall optimization. However, depending on the situation, it is not always possible to centrally control all the agents. As described above, even in a situation where a plurality of agents cannot be centrally controlled and distributed management is performed, it is preferable that a result of automatic negotiation between the plurality of agents can be brought close to the overall optimum.

Therefore, an object of the present invention is to provide a negotiation device, a negotiation system, a negotiation method, and a negotiation program capable of performing distributed management on automatic negotiation between a plurality of agents.

### Solution to Problem

A negotiation device according to the present invention includes: an execution planning means configured to calculate, with an offer from another agent as a constraint condition, a first value, which is a value of an optimal execution plan up to achievement of an objective, the optimal execution plan being planned based on a state transition by an action taken according to a policy of an own agent; and a determination means configured to determine, with the first value as an argument, whether or not a value calculated by a utility function, which is a function defining a utility of an execution plan of the own agent in a case where the offer from the other agent is accepted, is greater than a predetermined threshold value. The determination means determines to accept the offer from the other agent when the value is greater than the threshold value, and determines to reject the offer from the other agent when the value is equal to or less than the threshold value.

Another negotiation device according to the present invention includes: an execution planning means configured to calculate, with a desired execution state of an own agent as a constraint condition, a third value, which is a value of an optimal execution plan up to achievement of an objective, the optimal execution plan being planned based on a state transition by an action taken according to a policy of the own agent; and a determination means configured to determine, with the third value as an argument, whether or not a value calculated by a utility function, which is a function defining a utility of an execution plan of the own agent determined when the desired execution state is included, is greater than a predetermined threshold value. The determination means determines to propose the desired execution state to another agent when the value is greater than the threshold value, and determines not to propose the desired execution state when the value is equal to or less than the threshold value.

A negotiation system according to the present invention includes: a first negotiation device configured to determine an execution plan of a first agent based on an offer accepted from another agent; and a second negotiation device configured to output an offer from a second agent to the first negotiation device. The first negotiation device includes: a first execution planning means configured to calculate, with the offer from the second agent as a constraint condition, a first value, which is a value of an optimal execution plan up to achievement of an objective, the optimal execution plan being planned based on a state transition by an action taken according to a policy of the first agent; and a first determination means configured to determine, with the first value as an argument, whether or not a value calculated by a first utility function, which is a function defining a utility of an execution plan of the first agent in a case where the offer from the second agent is accepted, is greater than a predetermined threshold value. The second negotiation device includes: a second execution planning means configured to calculate, with a desired execution state of an own agent as a constraint condition, a third value, which is a value of an optimal execution plan up to achievement of an objective, the optimal execution plan being planned based on a state transition by an action taken according to a policy of the own agent; a second determination means configured to determine, with the third value as an argument, whether or not a value calculated by a second utility function, which is a function defining a utility of an execution plan of the own agent determined when the desired execution state is included, is greater than a predetermined threshold value; and an output means configured to output the execution state to the first negotiation device. The first determination means determines to accept the offer from the second agent when the value is greater than the threshold value, and determines to reject the offer from the second agent when the value is equal to or less than the threshold value. The second determination means determines to propose the desired execution state to the other agent when the value is greater than the threshold value, and determines not to propose the desired execution state when the value is equal to or less than the threshold value. The output means transmits the execution state to the first negotiation device when it is determined that the execution state is proposed. The first execution planning means calculates the first value with the execution state as a constraint condition.

A negotiation method according to the present invention includes: calculating, with an offer from another agent as a constraint condition, a first value, which is a value of an optimal execution plan up to achievement of an objective, the optimal execution plan being planned based on a state transition by an action taken according to a policy of an own agent; determining, with the first value as an argument, whether or not a value calculated by a utility function, which is a function defining a utility of an execution plan of the own agent in a case where the offer from the other agent is accepted, is greater than a predetermined threshold value; and determining to accept the offer from the other agent when the value is greater than the threshold value, and determining to reject the offer from the other agent when the value is equal to or less than the threshold value.

Another negotiation method according to the present invention includes: calculating, with a desired execution state of an own agent as a constraint condition, a third value, which is a value of an optimal execution plan up to achievement of an objective, the optimal execution plan being planned based on a state transition by an action taken according to a policy of the own agent; determining, with the third value as an argument, whether or not a value calculated by a utility function, which is a function defining a utility of an execution plan of the own agent determined when the desired execution state is included, is greater than a predetermined threshold value; and determining to propose the desired execution state to another agent when the value is greater than the threshold value, and determining not to propose the desired execution state when the value is equal to or less than the threshold value.

A negotiation program according to the present invention causes a computer to execute an execution planning process of calculating, with an offer from another agent as a constraint condition, a first value, which is a value of an optimal execution plan up to achievement of an objective, the optimal execution plan being planned based on a state transition by an action taken according to a policy of an own agent, and a determination process of determining, with the first value as an argument, whether or not a value calculated by a utility function, which is a function defining a utility of an execution plan of the own agent in a case where the offer from the other agent is accepted, is greater than a predetermined threshold value, and to determine, by the determination process, to accept the offer from the other agent when the value is greater than the threshold value, and determine, by the determination process, to reject the offer from the other agent when the value is equal to or less than the threshold value.

Another negotiation program according to the present invention causes a computer to execute an execution planning process of calculating, with a desired execution state of an own agent as a constraint condition, a third value, which is a value of an optimal execution plan up to achievement of an objective, the optimal execution plan being planned based on a state transition by an action taken according to a policy of the own agent, and a determination process of determining, with the third value as an argument, whether or not a value calculated by a utility function, which is a function defining a utility of an execution plan of the own agent determined when the desired execution state is included, is greater than a predetermined threshold value, and to determine, by the determination process, to propose the desired execution state to another agent when the value is greater than the threshold value, and determine, by the determination process, not to propose the desired execution state when the value is equal to or less than the threshold value.

### Advantageous Effects of Invention

According to the present invention, it is possible to perform distributed management on automatic negotiation between a plurality of agents.

### BRIEF DESCRIPTION OF DRAWINGS

FIG. 1 It depicts a block diagram illustrating a configuration example of an exemplary embodiment of a negotiation system according to the present invention.

FIG. 2 It depicts an explanatory diagram illustrating an operation example of performing automatic negotiation between negotiation devices.

FIG. 3 It depicts a flowchart illustrating an operation example of a first negotiation device.

FIG. 4 It depicts a flowchart illustrating an operation example of a second negotiation device.

FIG. 5 It depicts an explanatory diagram illustrating an example of a route plan of each agent.

FIG. 6 It depicts a block diagram illustrating an outline of a negotiation device according to the present invention.

FIG. 7 It depicts a block diagram illustrating an outline of another negotiation device according to the present invention.

FIG. 8 It depicts a block diagram illustrating an outline of a negotiation system according to the present invention.

FIG. 9 It depicts a schematic block diagram illustrating a configuration of a computer according to at least one exemplary embodiment.

### DESCRIPTION OF EMBODIMENTS

Hereinafter, exemplary embodiments of the present invention will be described with reference to the drawings. A negotiation system according to the present invention is a system in which each negotiation device performs negotiation with another negotiation device in order to execute an execution plan more preferable for the negotiation device itself.

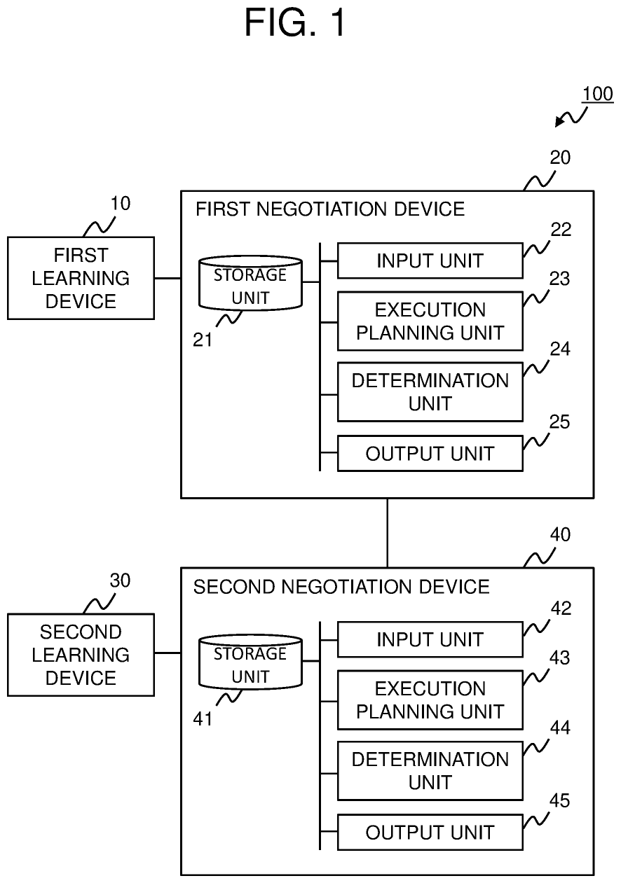

FIG. 1 is a block diagram illustrating a configuration example of an exemplary embodiment of a negotiation system according to the present invention. A negotiation system 100 according to the present exemplary embodiment includes a first learning device 10, a first negotiation device 20, a second learning device 30, and a second negotiation device 40.

In the present exemplary embodiment, the second negotiation device 40 proposes a desired execution state as an offer to the first negotiation device 20, and the first negotiation device determines whether or not to accept the offer. That is, in the present exemplary embodiment, it is assumed that the second negotiation device 40 serves as a trigger to start negotiation. However, the first negotiation device 20 may voluntarily propose a desired execution state. That is, the negotiation may be started by the first negotiation device 20 serving as a trigger.

The first negotiation device 20 and the second negotiation device 40 are connected to each other through a communication line. As described above, in the present exemplary embodiment, a description will be given as to a case in which two devices of the first negotiation device 20 and the second negotiation device 40 negotiate with each other while presenting offers of respective agents to determine an execution plan. However, the number of devices that perform negotiation is not limited to two, and may be three or more.

In the following description, in a case where it is not necessary to explicitly distinguish the entities of the first negotiation device 20 and the second negotiation device 40, an agent indicates an entity targeted by each negotiation device. When entities of the respective negotiation devices are explicitly distinguished and described, an agent that performs negotiation using the first negotiation device 20 is referred to as a first agent, and an agent that performs negotiation using the second negotiation device 40 is referred to as a second agent.

In addition, in the present exemplary embodiment, route negotiation by a plurality of (two) moving bodies is exemplified as a specific aspect of automatic negotiation. Route negotiation of a moving body is used in the above-described automatic guided vehicle or unmanned aircraft system, and the moving bodies mutually determine a route to a destination while avoiding collision between a plurality of moving bodies (alternatively, avoiding approach to a neighboring region). However, the mode of automatic negotiation is not limited to the route negotiation, and for example, the technology of automatic negotiation is similarly applicable to an autonomous car, an infrastructure, and the like.

The first learning device 10 learns a policy configured to maximize a value that the first agent can obtain in the future in a certain state. Specifically, the first learning device 10 generates a policy function π_{θ1}(a|s) having a function of determining an action a of an agent in a state s, a value function V_{θ1}(s) having a function of calculating a value of the state s of the agent, and a state transition function p₁(s′|s, a) having a function of calculating a state s′ to be obtained next when the certain action a is taken in the certain state s, respectively. It is noted that the state transition function can also be regarded as a function of advancing the time of the state. It is noted that, in the following description, a value calculated by the value function V(s) may be referred to as a value V(s).

For example, the first learning device 10 may generate, by reinforcement learning, the policy function π_{θ1}(a|s), the value function V_{θ1}(s), and the state transition function p₁(s′|s, a) described above. However, a method of learning, by the first learning device 10, the policy function, the value function, and the state transition function is not limited to the reinforcement learning described above, and any machine learning technology capable of generating a model representing the policy function, the value function, and the state transition function may be used.

For example, the first learning device 10 may calculate a policy function and a value function exemplified below, for example, using only an action value function Q(s, a) for calculating a value in the state s and the action a. r(s, a) of the action value function Q(s, a) exemplified below is a reward function in a case where the action a is taken in the state s. Specifically, the action value function Q(s, a) of the state s and the action a at the time t exemplified below means that the same is equivalent to the sum of a reward function r(s, a) at the time t and a value function V(s′) of the state s′ at the time t+1, which is one step ahead, calculated with the state transition function of p(s′|s, a) as an expected value. It is noted that this action value function is one of the Bellman equations having various expressions, and is not limited to the following expressions.

$$Q ( s , a ) = r ( s , a ) + {\sum }_{s ′} p ( {s}^{′} \vert s , a ) V ( {s}^{′} ) \qquad [ Math . 1 ]$$

$$π ( a \vert s ) = {argmax}_{a} Q ( s , a )$$

$$V ( s ) = {\sum }_{a} π ( a \vert s ) Q ( s , a )$$

In addition, the state transition function can be defined in principle even by a method not using machine learning. Therefore, the first learning device 10 may use a separately programmed simulation as the state transition function, or may access a database including past accumulated data to acquire the state transition function. In addition, the state transition function and the policy function can be handled stochastically or deterministically.

The first learning device 10 outputs the generated policy function, value function, and state transition function to the first negotiation device 20. It is noted that the first learning device may store the generated policy function, value function, and state transition function in a storage unit 21 of the first negotiation device 20 described later.

The first negotiation device 20 is a device that determines a more preferable execution plan desired by the first agent. In the present exemplary embodiment, it is assumed that the first negotiation device 20 operates as a device configured to accept an offer from the second negotiation device 40 and to determine whether or not to accept the offer. The first negotiation device 20 includes the storage unit 21, an input unit 22, an execution planning unit 23, a determination unit 24, and an output unit 25.

The storage unit 21 stores the policy function π_{θ1}(a|s), the value function V_{θ1}(s), and the state transition function p₁(s′|s, a) described above. In addition, the storage unit 21 may store parameters used for processing by the execution planning unit 23 and the determination unit 24 to be described later, and various types of information received from the second negotiation device 40. The storage unit 21 is implemented by, for example, a magnetic disk or the like.

In the present exemplary embodiment, a description will be given, as an example, as to a case in which the policy function, the value function, and the state transition function used by the first negotiation device 20 are generated by the first learning device 10. However, the policy function, the value function, and the state transition function may be generated by the first negotiation device 20 itself, another device (not illustrated), or the like and stored in the storage unit 21. In this case, the negotiation system 100 may not include the first learning device 10.

The input unit 22 accepts an input of an offer related to negotiation from the other agent (more specifically, the second negotiation device 40). Specifically, the input unit 22 accepts an input of a constraint that can affect an execution plan of the other agent as an offer ω related to the negotiation. For example, in the case of the route negotiation described above, the input unit 22 may accept a combination of the position on the route and the time as an offer from the other agent. Furthermore, the input unit 22 may accept an input including a consideration for the offer.

In addition, the input unit 22 may accept inputs of the policy function π_{θ1}(a|s), the value function V_{θ1}(s), and the state transition function p₁(s′|s, a) described above and store the same in the storage unit 21. It is noted that the policy function and the value function accepted by the input unit 22 are not limited to those generated by the reinforcement learning, and may be those generated by any machine learning or those generated in advance by a user or the like.

The execution planning unit 23 sets the offer from the other agent (here, the second agent) as a constraint condition, and calculates a value (hereinafter, the same may be referred to as a first value) of an optimal execution plan up to the achievement of an objective, the optimal execution plan being planned based on a state transition by an action taken according to a policy of the own agent (here, the first agent). For example, in the case of the route negotiation described above, the optimal execution plan up to the achievement of the objective means an optimal route up to the destination.

For example, the execution planning unit 23 may determine, with the accepted offer ω as a constraint condition, an execution plan configured to maximize a value of the value function V_{θ1}(s) to be obtained in the future in the case of following the policy function π_{θ1}(a|s) of the first agent based on the state transition function p₁(s′|s, a). Specifically, the execution planning unit 23 may determine the execution plan configured to maximize the value of the value function by the policy function based on the state transition function by using the offer ω from the other agent as a constraint condition to be excluded from the execution plan, and calculate the value at that time.

For example, in the case of the route negotiation described above, the execution planning unit 23 generates the execution plan so as not to include the position and time on the route included in the offer from the other agent. It is noted that a method of determining an optimal execution plan is freely and selectively performed. For example, the execution planning unit 23 may determine the optimal execution plan in a general reinforcement learning framework while considering the offer ω as a constraint condition.

In general, an execution plan including the offer ω as a constraint condition has a stricter condition than that of an execution plan not including the offer ω as a constraint condition, and as such, a value is calculated to be low. Therefore, the execution planning unit 23 may also calculate a value of an optimal execution plan in a case where there is no offer ω from the other agent. In other words, the execution planning unit 23 may calculate, according to a policy of the own agent, a value (hereinafter, the same may be referred to as a second value) of an optimal execution plan up to the achievement of an objective, the optimal execution plan being planned based on the state transition function.

Hereinafter, a specific example of a method of calculating a value will be described. For example, a model expressing a route is represented by the following Equation 1 under approximation by a Markov decision process (MDP).

$$\begin{matrix}[ Math . 2 ] & \\ p ( {s}_{0} , {a}_{1} , … {s}_{H} , {a}_{H} , {s}_{H + 1} ) = p ( {s}_{0} ) {\prod }_{t = 0}^{H} p ( {s}_{t + 1} \vert {s}_{t} , {a}_{t} ) {π}_{θ} ( {a}_{t} \vert {s}_{t} ) & ( Equation 1 )\end{matrix}$$

In addition, the following Equation 2 is defined from the policy function π_{θ}(a|s) and the state transition function p(s′|s, a) learned by the reinforcement learning.

$$\begin{matrix}[ Math . 3 ] & \\ {\sum }_{a} {π}_{θ} ( a \vert s ) p ( {s}^{′} \vert s , a ) = {p}_{θ} ( {s}^{′} \vert s ) & ( Equation 2 )\end{matrix}$$

Then, by deterministic approximation, the execution planning unit 23 calculates an optimum state s′_{ω}, with a state s_{ω} occupied by an offer from the other agent as a constraint condition by using the following Equation 3. It is noted that, in Equation 3, S is a set of states that can be obtained.

$$\begin{matrix}[ Math . 4 ] & \\ {s}_{ω}^{′} = {argmax}_{{s}^{′} ∈ S \backslash {s}_{ω}} {p}_{θ} ( {s}^{′} \vert s ) & ( Equation 3 )\end{matrix}$$

Furthermore, the execution planning unit 23 calculates a value (that is, the first value) in this state as V(s′_{ω}). It is noted that, in a case where there is no constraint condition s_{ω}, the execution planning unit 23 calculates an optimal state s′ and a value V(s′) (that is, the second value) of the agent by using the following Equation 4.

$$\begin{matrix}[ Math . 5 ] & \\ {s}^{′} = {argmax}_{{s}^{′}} {p}_{θ} ( {s}^{′} \vert s ) & ( Equation 4 )\end{matrix}$$

The determination unit 24 determines, with the above-described value (first value) as an argument, whether or not a value calculated by a function (hereinafter, the same is referred to as a first utility function) U_{θ}(ω) defining the utility of the execution plan of the own agent determined in a case where the offer ω from the other agent is accepted is greater than a predetermined threshold value Uₜₕ₁. Then, in a case where a calculated value U_{θ1}(ω) is greater than the threshold value Uₜₕ₁, the determination unit 24 determines to accept the offer ω from the other agent (accept the generated execution plan). On the other hand, in a case where the calculated value U_{θ1}(ω) is equal to or less than the threshold value Uₜₕ₁, the determination unit 24 determines to reject the offer ω from the other agent (the generated execution plan is not accepted).

The first utility function is defined as a function, the value of which can be calculated to be greater as the execution plan is more preferable. For example, the first utility function may be defined so as to derive a magnitude relationship (specifically, a preferable proposal content has higher utility) of values according to preferences (for example, which proposal content is more preferable) regarding different offers (proposal).

For example, a function for calculating an absolute value of a value V_{θ}(s) may be defined as the first utility function. In addition, for example, a function that calculates, as the utility, a difference ΔV_{θ} between the value (that is, the second value) of the optimal execution plan in a case where there is no offer ω from the other agent and the value (that is, the first value) of the execution plan including the offer ω as a constraint condition may be defined as the first utility function. Furthermore, the first utility function may include a consideration obtained in a case where an offer from the other agent is accepted.

Hereinafter, an example of a specific method of defining the first utility function will be described. However, the method of defining the first utility function is not limited to the following specific method.

Here, it is assumed that a state s_{b} and a consideration r_{b} at the time b are an offer ω from the other agent. That is, ω:=(s_{b}, r_{b}). The state s_{b} is, for example, position information at the time b.

A value V_{θ1}(s_{b+T}) (that is, the second value) at the time b+T (where T=1) in a case where the state s_{b} is not used as a constraint condition is obtained by calculating an optimal route plan using the policy function π_{θ1}(a|s), the value function V_{θ1}(s), and the state transition function p₁(s′|s, a). Similarly, a value V_{θ1}(s′_{b+T}) (that is, the first value) at the time b+T in a case where the state s_{b} is used as a constraint condition (that is, S_{S}_{_{b}}) can be similarly obtained.

In this case, a difference ΔV_{θ1} between a value in a case where the state s_{b} is included in the constraint condition and a value in a case where the state is not included therein can be calculated by ΔV_{θ1}=V_{θ1}(s_{b+T})−V_{θ1}(s′_{b+T}). Then, in a case where the consideration r_{b} is considered, the first utility function can be defined as U_{θ1}(ω):=ΔV_{θ1}+r_{b} so as to include the consideration r_{b}. In this case, the determination unit 24 may determine to accept the offer ω when the offer ω satisfies U_{θ1}(ω)≥Uₜₕ₁.

The output unit 25 outputs a negotiation content corresponding to the determination result of the determination unit 24 to the other agent. Specifically, in a case where the determination unit 24 determines to accept the offer ω from the other agent, the output unit 25 outputs the negotiation content to the other agent (here, the second negotiation device 40) to accept the offer ω.

On the other hand, in a case where the determination unit 24 determines to reject the offer co from the other agent, the output unit 25 outputs the negotiation content to the other agent to reject the offer ω. Furthermore, at this time, the output unit 25 may output an alternative offer (counter offer) to the other agent together with a content indicating rejection of the offer.

Specifically, in a case where a calculated value is equal to or less than the threshold value Uₜₕ₁, the output unit 25 may make, as a counter offer, another proposal that satisfies the threshold value Uₜₕ₁ or greater permitted by the agent itself to the other party (the other agent). In this way, it is possible to automatically calculate the agreement points of both agents. It is noted that a method of making another proposal that satisfies the threshold value Uₜₕ₁ or greater permitted by the agent itself will be described in detail in the description of the second negotiation device 40.

A method of determining the counter offer presented by the output unit 25 is freely and selectively performed. For example, the output unit 25 may transmit a consideration in the case of accepting the offer ω from the other agent, or may transmit, to the other agent, the same contents as the offer from the other agent.

Here, the negotiation process may be repeated many times until an agreement is reached. A method of repeating the negotiation depends on a protocol of negotiation. For example, a protocol may be used in which one is used to only make a proposal and the other one is used to agree with the proposal or reject the same. In addition, a protocol such as (price reduction negotiation) in which offers are exchanged with each other may be used. In addition, a protocol such as the AOP described in NPL 2 may be used. Furthermore, in the present exemplary embodiment, a description is given, as an example, as to a case in which a threshold value is a constant, but the threshold value may be defined by a function Uₜₕ(tₙ) that changes for each step to of each negotiation, instead of the constant. In this case, for each step to of each negotiation, a value calculated by the function may be used as a threshold value.

As described above, the number of automatic negotiations with another agent is not limited to one, and may be a plurality of times. That is, the negotiation process itself may not be performed once, but may be repeatedly performed until the agreement between mutual agents is reached. As a result, it is an object to search for a situation that is mutually beneficial. That is, by automatic negotiation using a computer, it is also possible to calculate an optimal agreement between agents by high-speed negotiation several tens of thousands of times that cannot be performed manually.

The input unit 22, the execution planning unit 23, the determination unit 24, and the output unit 25 are implemented by a processor (for example, a central processing unit (CPU) or a graphics processing unit (GPU)) of a computer that operates according to a program (negotiation program).

For example, the program may be stored in the storage unit 21, and the processor may read the program to operate as the input unit 22, the execution planning unit 23, the determination unit 24, and the output unit 25 according to the program. In addition, the function of the first negotiation device 20 may be provided in a software as a service (SaaS) format.

Furthermore, each of the input unit 22, the execution planning unit 23, the determination unit 24, and the output unit 25 may be implemented by dedicated hardware. In addition, some or all of the components of each device may be implemented by general-purpose or dedicated circuitry, a processor, or the like, or a combination thereof. These may be configured by a single chip or may be configured by a plurality of chips connected via a bus. Some or all of the components of each device may be implemented by a combination of the above-described circuit or the like and a program.

In addition, in a case where some or all of the components of the first negotiation device are implemented by a plurality of information processing devices, circuits, and the like, the plurality of information processing devices, circuits, and the like may be disposed in a centralized manner or in a distributed manner. For example, the information processing device, the circuit, and the like may be implemented as a mode in which the same are connected to each other via a communication network such as a client server system and a cloud computing system.

The second learning device 30 learns a policy function configured to maximize a value to be obtained by the second agent in the future in a certain state. It is noted that a method of learning, by the second learning device 30, the policy function, the value function, and the state transition function is also freely and selectively performed. For example, similarly to the first learning device 10, the second learning device 30 may generate the policy function π_{θ2}(a|s), the value function V_{θ2}(s), and the state transition function p₂(s′|s, a) described above by reinforcement learning.

The second learning device 30 outputs the generated policy function, value function, and state transition function to the second negotiation device 40. It is noted that the second learning device 30 may also store the generated policy function, value function, and state transition function in a storage unit 41 of the second negotiation device 40 described later.

The second negotiation device 40 is a device that determines a more preferable execution plan desired by the second agent. In the present exemplary embodiment, the second negotiation device 40 operates as a device that proposes a desired execution state as an offer to the first negotiation device 20.

In an actual situation, if there is an advantage to an agent in a case where a state (specifically, a route plan) already held by the other party can be used, negotiation is started with the state as a constraint condition. For example, with reference to an external system, it is grasped that one agent has already reserved a predetermined state by a route plan. Then, if a part of the route can be used, a value and a route plan in that case are obtained.

The second negotiation device 40 includes the storage unit 41, an input unit 42, an execution planning unit 43, a determination unit 44, and an output unit 45.

The contents stored in the storage unit 41 are similar to the contents stored in the storage unit 21 of the first negotiation device 20.

The input unit 42 accepts an input of a state held by the other agent (here, the first agent). For example, in order to confirm whether or not it is necessary to negotiate the execution plan, the input unit 42 may inquire of another negotiation device (here, the first negotiation device 20) about the state held by the other party. In the case of route negotiation, the held state is, for example, position information scheduled to be used by the other agent at a certain time. As a result, the second negotiation device 40 can determine whether it is necessary to propose a negotiation content regarding the execution plan desired by the second negotiation device to the other negotiation device.

However, the second negotiation device 40 may voluntarily transmit (propose) the execution plan to the other agent regardless of the state held by the other agent. In this case, the input unit 42 may not accept an input of a state held by the other agent.

Similarly to the input unit 22 of the first negotiation device 20, the input unit 42 may accept inputs of the policy function π_{θ2}(a|s), the value function V_{θ2}(s), and the state transition function p₂(s′|s, a) and store the inputs in the storage unit 41.

The execution planning unit 43 sets a desired execution state of the own agent (here, the second agent) as a constraint condition, and calculates a value (hereinafter, the same may be referred to as a third value) of an optimal execution plan up to the achievement of an objective, the optimal execution plan being planned based on a state transition by an action taken according to a policy of the own agent (here, the second agent). For example, in the case of the route negotiation described above, the desired execution state is a state in which the own agent holds a certain position at a certain time, in other words, a state in which holding by the other agent can be excluded.

For example, the execution planning unit 43 may determine, with the desired execution state ω as a constraint condition, an execution plan configured to maximize a value of the value function V_{θ2}(s) to be obtained in the future in the case of following the policy function π_{θ2}(a|s) of the second agent based on the state transition function p₂(s′|s, a). Specifically, the execution planning unit 43 may determine the execution plan configured to maximize the value of the value function by the policy function based on the state transition function by using the desired execution state ω as a constraint condition to be necessarily included in the execution plan, and calculate the value at that time.

For example, in the case of the route negotiation described above, the execution planning unit 43 generates the execution plan so as to constantly include the position and time on the route indicated by the desired execution state. It is noted that a method of determining the optimal execution plan is freely and selectively performed, and a method similar to that of the execution planning unit 23 of the first negotiation device 20 may be used.

The determination unit 44 determines, with the above-described value (the third value) as an argument, whether or not a value calculated by a function (hereinafter, the same is referred to as a second utility function.) U_{θ}(ω) defining the utility of the execution plan of the own agent determined in a case where the desired execution state ω is included is greater than a predetermined threshold value Uₜₕ₂. Then, in a case where a calculated value U_{θ2}(ω) is greater than the threshold value Uₜₕ₂, the determination unit 44 determines to propose the desired execution state ω to the other agent. On the other hand, in a case where the calculated value U_{θ2}(ω) is equal or less than the threshold value Uₜₕ₂, the determination unit 44 determines not to propose the desired execution state ω.

Similarly to the first utility function, the second utility function is also defined as a function, the value of which is calculated to be greater as the execution plan is more preferable. Similarly to the first utility function, a function for calculating the absolute value of the value V_{θ}(s) may be defined as the second utility function.

In addition, for example, a function that calculates, as the utility, a difference ΔV_{θ} between a value (hereinafter, the same is referred to as a fourth value.) of the optimal execution plan in a case where the desired execution state ω is not included in the constraint condition and a value (that is, the third value) of the optimal execution plan in a case where the desired execution state ω is included in the constraint condition may be defined as the second utility function. Furthermore, the second utility function may include a consideration to be paid when a proposal is accepted by the other agent.

Hereinafter, an example of a specific method of defining the second utility function will be described. However, the method of defining the second utility function is not limited to the following specific method.

Here, it is assumed that the state s_{b} and the consideration r_{b} at the time b are the execution state ω desired by the own agent. That is, ω:=(s_{b}, r_{b}). The state s_{b} is, for example, position information at the time b.

A value V_{θ2}(s_{b+T}) (that is, the fourth value) at the time b+T (here, T=1) in a case where the state s_{b} is not used as a constraint condition is obtained by calculating an optimal route plan using the policy function π_{θ2}(a|s), the value function V_{θ2}(s), and the state transition function p₂(s′|s, a). Similarly, a value V_{θ2}(s′_{b+T}) (that is, the third value) at the time b+T in a case where the state s_{b} is used as a constraint condition (that is, S+s_{b}) can be similarly obtained.

In this case, a difference ΔV_{θ2} between a value in a case where the state s_{b} is included in the constraint condition and a value in a case where the state is not included therein can be calculated by ΔV_{θ2}=V_{θ2}(s′_{b+T})−V_{θ2}(s_{b+T}). Then, in a case where the consideration r_{b} is considered, the utility function can be defined as U_{θ2}(ω):=ΔV_{θ2}−r_{b} so as to include the consideration r_{b}. In this case, the determination unit 24 may determine to propose a desired execution state when the execution state ω satisfies U_{θ2}(ω)≥Uₜₕ₂.

The output unit 45 outputs, to the other agent, a negotiation content corresponding to the determination result of the determination unit 44. Specifically, in a case where the determination unit 44 determines to propose the desired execution state ω to the other agent, the output unit 45 outputs, to the other agent, a negotiation content indicating the proposal of the execution state ω.

On the other hand, in a case where the determination unit 44 determines not to propose the desired execution state ω to the other agent, the output unit 45 determines not to output the proposal to the other agent. Furthermore, at this time, the output unit 45 may instruct the determination unit 44 to determine a proposal related to another execution state ω. Specifically, the output unit 45 may cause the determination unit 44 to determine another proposal that satisfies the threshold value Uₜₕ₂ or greater permitted by the agent itself in a case where a proposal is equal to or less than a threshold value Uₜₕ₃.

The first negotiation device 20 may include the configuration of the second negotiation device 40, and the second negotiation device 40 may include the configuration of the first negotiation device 20. That is, each of the first negotiation device 20 and the second negotiation device 40 may accept an offer from another negotiation device, and determine a more preferable execution plan desired by each agent in consideration of the offer. In this case, for example, the first negotiation device 20 may include the storage unit 41, the input unit 42, the execution planning unit 43, the determination unit 44, and the output unit 45 of the second negotiation device 40.

In this case, when accepting an input of a counter offer from the second negotiation device with respect to the proposal output by the output unit 45, the first negotiation device 20 may determine whether to accept the offer indicated by the accepted input. Then, the first negotiation device 20 may repeatedly negotiate with the second negotiation device 40 until a predetermined condition is satisfied.

The input unit 42, the execution planning unit 43, the determination unit 44, and the output unit 45 are implemented by a processor (for example, a central processing unit (CPU) or a graphics processing unit (GPU)) of a computer that operates according to a program (negotiation program).

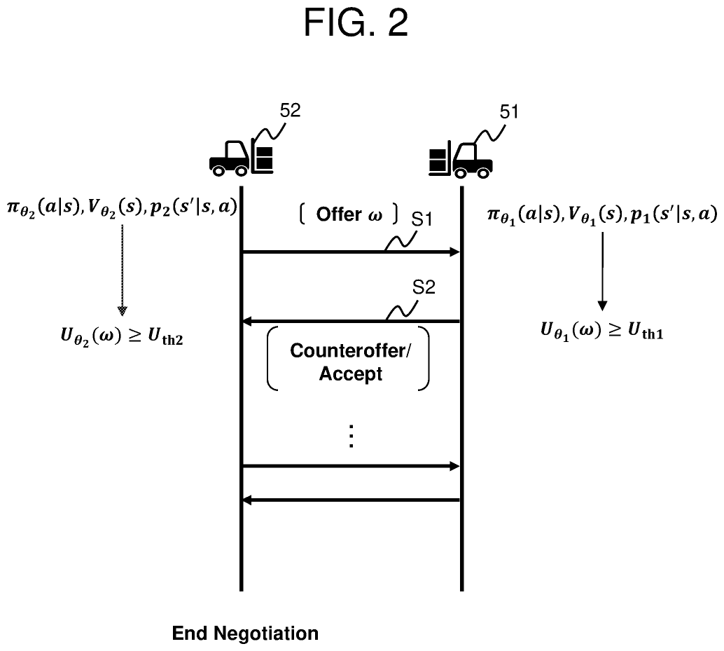

FIG. 2 is an explanatory diagram illustrating an operation example of performing automatic negotiation between the first negotiation device 20 and the second negotiation device A second agent 52 (more specifically, the second negotiation device 40) makes an offer ω to a first agent 51 (more specifically, the first negotiation device 20) (step S1). The first negotiation device 20 calculates a utility U_{θ1}(ω) by applying a value calculated based on a policy function π_{θ1}(a|s), a value function V_{θ1}(s), and a state transition function p₁(s′|s, a) to a first utility function, and compares the calculated utility with a threshold value Uₜₕ₁. Then, the first negotiation device transmits, to the second agent 52, information indicating acceptance of the offer or a counter offer according to the determination based on the comparison result (step S2).

For example, when the second agent 52 receive the counter offer, the second negotiation device 40 calculates a utility U_{θ2}(ω) by applying a value calculated based on a policy function π_{θ2}(a|s), a value function V_{θ2}(s), and a state transition function p₂(s′|s, a) to a second utility function, and compares the calculated utility with a threshold value Uₜₕ₂. Then, the second negotiation device 40 transmits, to the first agent 51, information indicating acceptance of the offer or a counter offer according to the determination based on the comparison result.

Thereafter, the processing of steps S1 and S2 is repeated until the negotiation is completed. Specifically, the negotiation between the first agent 51 and the second agent 52 may be performed based on, for example, the AOP described in NPL 2.

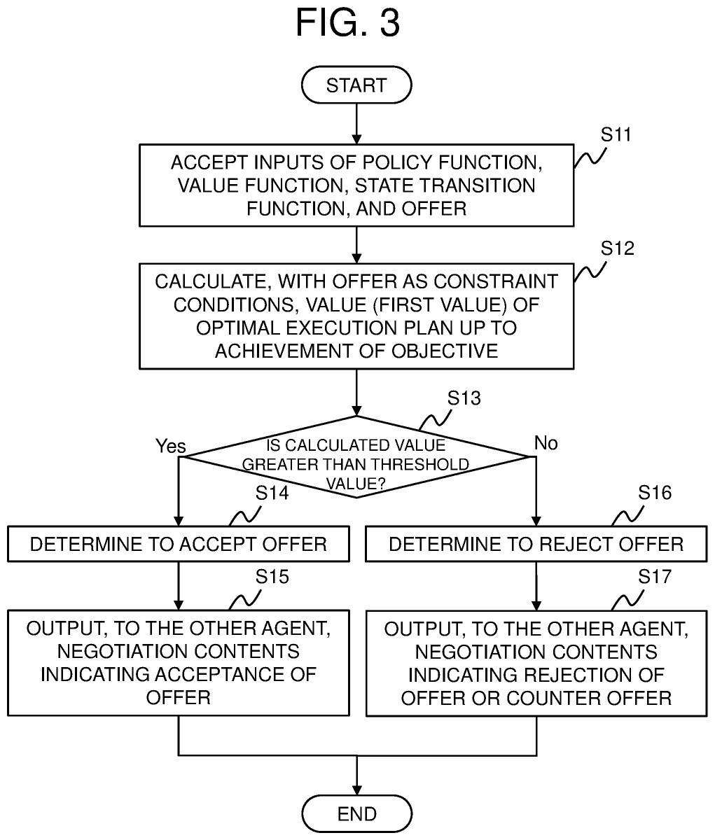

Next, an operation of the negotiation system of the present exemplary embodiment will be described. FIG. 3 is a flowchart illustrating an operation example of the first negotiation device of the present exemplary embodiment. First, the input unit 22 accepts inputs of a policy function π_{θ1}(a|s), a value function V_{θ1}(s), a state transition function p₁(s′|s, a), and an offer ω from the other agent (step S11).

The execution planning unit 23 calculates, with the offer from the other agent as a constraint condition, a value (first value) of an optimal execution plan up to the achievement of an objective (step S12). The determination unit 24 determines, with the first value as an argument, whether or not a value U_{θ1}(ω) calculated by a first utility function is greater than a predetermined threshold value Uₜₕ₁ (step S13).

When U_{θ1}(ω) is greater than Uₜₕ₁ (Yes in step S13), the determination unit 24 determines to accept the offer from the other agent (step S14). Then, the output unit 25 outputs, to the other agent, a negotiation content indicating the acceptance of the offer ω (step S15).

On the other hand, when U_{θ1}(ω) is equal to or less than Uₜₕ₁ (No in step S13), the determination unit 24 determines to reject the offer from the other agent (step S16). Then, the output unit 25 outputs, to the other agent, a negotiation content indicating the rejection of the offer ω or a counter offer (step S17).

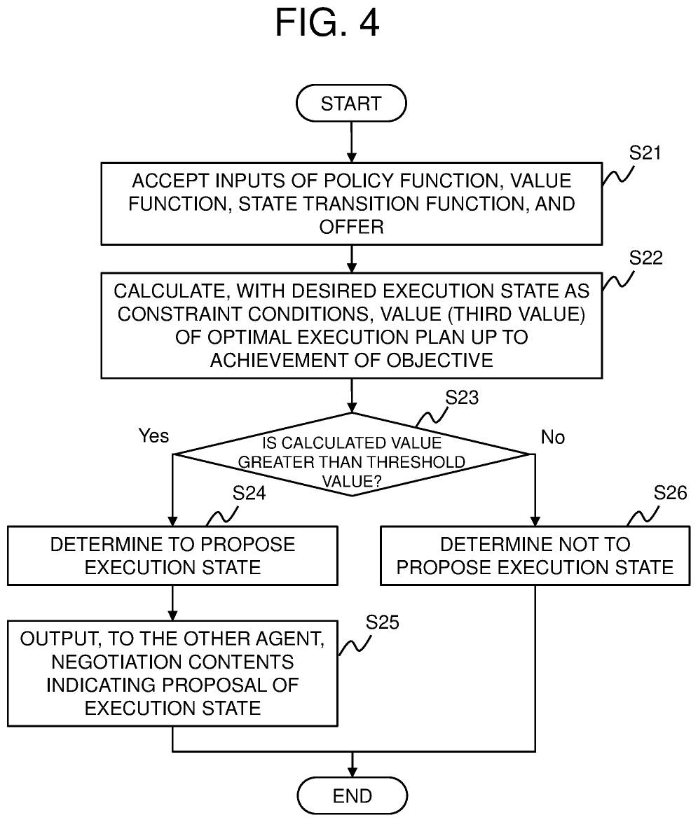

FIG. 4 is a flowchart illustrating an operation example of the second negotiation device 40 of the present exemplary embodiment. First, the input unit 42 accepts inputs of a policy function π_{θ2}(a|s), a value function V_{θ2}(s), and a state transition function p₂(s′|s, a) (step S21). It is noted that the input unit 42 may accept an input of a state held by the other agent (here, the first agent).

The execution planning unit 43 calculates, with a desired execution state of the own agent as a constraint condition, a value (the third value) of an optimal execution plan up to the achievement of an objective (step S22). The determination unit 44 determines, with the third value as an argument, whether or not a value U_{θ2}(ω) calculated by a second utility function is greater than a predetermined threshold value Uₜₕ₂ (step S23).

When U_{θ2}(ω) is greater than Uₜₕ₂ (Yes in step S23), the determination unit 44 determines to propose a desired execution state (step S24). Then, the output unit 45 outputs, to the other agent, a negotiation content indicating the proposal of an execution state ω (step S25). Thereafter, the processing from step S11 illustrated in FIG. 3 may be performed in the other agent (In the present exemplary embodiment, the first negotiation device 20).

On the other hand, when U_{θ2}(ω) is equal to or less than Uₜₕ₂ (No in step S23), the determination unit 44 determines not to propose the desired execution state (step S26). At this time, the output unit 25 may cause the determination unit 44 to determine another proposal that satisfies the threshold value Uₜₕ₂ or greater permitted by the agent itself.

As described above, in the present exemplary embodiment, the execution planning unit 23 calculates, with an offer from the second agent as a constraint condition, a value (the first value) of an optimal execution plan up to the achievement of an objective, the optimal execution plan being planned based on a state transition function according to a policy of the first agent, and the determination unit 24 determines whether or not a value calculated by a utility function is greater than a predetermined threshold value. Then, the determination unit 24 determines to accept the offer from the second agent in a case where the value is greater than the threshold value, and determines to reject the offer from the second agent in a case where the value is equal to or less than the threshold value. Accordingly, it is possible to perform distributed management on automatic negotiation between a plurality of agents.

Furthermore, in the present exemplary embodiment, the execution planning unit 43 calculates, with a desired execution state of the own agent (here, the second agent) as a constraint condition, a value (the third value) of an optimal execution plan up to the achievement of an objective, the optimal execution plan being planned based on a state transition by an action taken according to a policy of the own agent. In addition, the determination unit 44 determines whether or not a value calculated by a second utility function is greater than a predetermined threshold value. Then, the determination unit 44 determines to propose the desired execution state w to the other agent in a case where the value is greater than the threshold value, and determines not to propose the desired execution state win a case where the value is equal to or less than the threshold value. In this configuration as well, it is possible to perform distributed management on automatic negotiation between a plurality of agents.

In the first exemplary embodiment and the second exemplary embodiment, a description has been given, as an example, as to a case in which each negotiation device is an automatic negotiation device implemented by a computer or the like. However, in the negotiation system according to the present invention, one negotiation device (agent) can be operated by a person as well. In this case, an operator may exchange messages with the agent via an input device such as a personal computer (PC).

Next, a specific example of route negotiation using the negotiation system of the above-described exemplary embodiment will be described. The present specific example assumes a situation in which each of the first agent and the second agent performs a route plan, and negotiation with another agent is required in the course of the route plan.

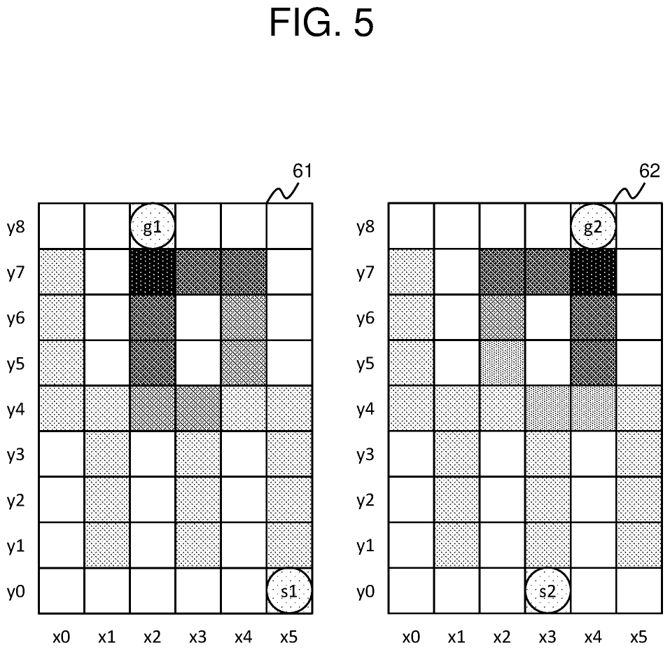

FIG. 5 is an explanatory diagram illustrating an example of a route plan of each agent. A route plan 61 illustrated in FIG. 5 is a route plan of the first agent, and a route plan 62 is a route plan of the second agent. Specifically, the route plan 61 is a plan in which the first agent moves from a start point s1=(x5, y0) to a goal point g1=(x2, y8) via (x5, y4) and (x2, y4). Furthermore, the route plan 62 is a plan in which the second agent moves from a start point s2=(x3, y0) to a goal point g2=(x4, y8) via (x3, y4) and (x4, y4).

In this case, in the route plan 61 and the route plan 62, since the first and second agents simultaneously pass through (x4, y4) at the time t=5, the plan cannot be executed as it is. Here, a situation is assumed in which the first agent preferentially executes the route plan and the second agent re-plans the route plan. Specifically, the first agent makes an offer to the second agent to avoid (x4, y4) at the time t=5. At this time, the first agent may notify the second agent of a consideration for the offer together.

In this case, the execution planning unit 43 of the second negotiation device 40 calculates, with the offer from the other agent including time and position information as a constraint condition, a value (the first value) of an optimal route plan based on a policy of the own agent and a state transition function. Specifically, the execution planning unit 43 adds a constraint to avoid a state in which the second agent exists at (x4, y4) at the time t=5, plans an optimal route based on the learned policy function, value function, and state transition function, and calculates a value at that time.

Here, it is assumed that a utility function is defined by a difference between the value (that is, the first value) of the optimal route plan in a case where the constraint condition is considered and a value (that is, the second value) of an optimal route plan in a case where the constraint condition is not considered. At this time, the execution planning unit 43 also calculates the value (the second value) of the optimal route plan (that is, a route plan in a case where the second agent passes through (x4, y4) at the time t=5) in a case where the constraint condition is not considered. Then, the determination unit 44 determines whether or not the value calculated by the utility function is greater than a predetermined threshold value.

When the calculated value is greater than the threshold value, the second agent (more specifically, the determination unit 44) determines to accept the offer from the first agent. At this time, for example, the second agent (more specifically, the output unit 45) may notify the first agent that the offer is accepted on the assumption that the optimal route plan in consideration of the constraint condition is executed.

On the other hand, when the calculated value is equal to or less than the threshold value, the second agent (more specifically, the determination unit 44) determines to reject the offer from the first agent. At this time, the second agent (more specifically, the output unit 45) may transmit, to the first agent, for example, a counter offer for requesting an additional consideration together with a notification indicating the rejection of the offer.

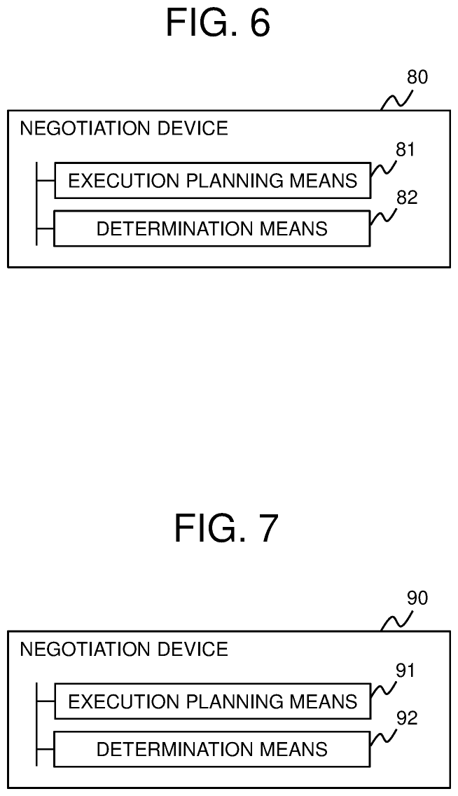

Next, an outline of the present invention will be described. FIG. 6 is a block diagram illustrating an outline of a negotiation device according to the present invention. A negotiation device 80 (for example, the first negotiation device 20) according to the present invention includes: an execution planning means 81 (for example, the execution planning unit 23) configured to calculate, with an offer (for example, ω) from the other agent (for example, the second agent) as a constraint condition, a first value, which is a value of an optimal execution plan up to the achievement of an objective, the optimal execution plan being planned based on a state transition (for example, a state transition function p₁(s′|s, a)) by an action taken according to a policy (for example, π_{θ1}(a|s)) of an own agent (for example, the first agent); and a determination means 82 (for example, the determination unit 24) configured to determine, with the first value as an argument, whether or not a value (for example, U_{θ1}(ω)) calculated by a utility function (for example, the first utility function: U_{θ}(ω)), which is a function defining a utility of an execution plan of the own agent in a case where the offer from the other agent is accepted, is greater than a predetermined threshold value (for example, the threshold value Uₜₕ₁).

The determination means 82 determines to accept the offer from the other agent when the value is greater than the threshold value, and determines to reject the offer from the other agent when the value is equal to or less than the threshold value.

According to such a configuration, it is possible to perform distributed management on automatic negotiation between a plurality of agents.

In addition, the negotiation device 80 may include an input means (for example, the input unit 22) configured to accept inputs of a policy function (for example, π_{θ}(a|s)) having a function of determining an action (for example, a) of the own agent in a certain state (for example, s), a value function (for example, value V_{θ}(s)) having a function of calculating a value of the state of the own agent, a state transition function (for example, p(s′|s, a)) having a function of calculating a state to be obtained next when the action is taken in the state, and the offer (for example, ω) from the other agent. Then, the execution planning means 81 may determine, with the accepted offer as a constraint condition, an execution plan configured to maximize a value of the value function in the case of following the policy function based on the state transition function.

Specifically, the input means may accept inputs of a policy function, a value function, and a state transition function generated by reinforcement learning (for example, performed by the first learning device 10).

In addition, the negotiation device 80 may include an output means (for example, the output unit 25) configured to output a negotiation content corresponding to a determination result of the determination means 82 to the other agent. Then, when the determination means 82 determines to reject the offer from the other agent, the output means may output, to the other agent, an alternative offer (for example, counter offer) together with a content indicating the rejection of the offer.

Furthermore, the execution planning means 81 may calculate a second value, which is a value of an optimal execution plan in a case where there is no offer from the other agent. Then, the determination means 82 may calculate a value based on a utility function of calculating, as a utility, a difference (for example, ΔV_{θ} described above) between the second value and the first value, and determine whether or not the calculated value is greater than a predetermined threshold value. According to such a configuration, it is possible to make a determination based on a difference between a case where an offer is accepted and a case where the offer is not accepted.

Specifically, the execution planning means 81 may calculate, with an offer from the other agent including time and position information as a constraint condition, the first value, which is a value of an optimal route plan, based on a policy function and a state transition function of the own agent. Then, the determination means 82 may determine whether or not a value calculated by a utility function defining, as a utility, a difference between the first value and the second value, which is the value of the optimal route plan in a case where the constraint condition is not considered, is greater than a predetermined threshold value.

FIG. 7 is a block diagram illustrating an outline of another negotiation device according to the present invention. A negotiation device 90 (for example, the second negotiation device 40) according to the present invention includes: an execution planning means 91 (for example, the execution planning unit 43) configured to calculate, with a desired execution state of the own agent as a constraint condition, a third value, which is a value of an optimal execution plan up to achievement of an objective, the optimal execution plan being planned based on a state transition by an action taken according to a policy of the own agent; and a determination means 92 configured to determine, with the third value as an argument, whether or not a value calculated by a utility function (for example, the second utility function), which is a function defining a utility of an execution plan of the own agent determined in a case where the desired execution state is included, is greater than a predetermined threshold value (for example, the threshold value Uₜₕ₂).

The determination means 92 determines to propose the desired execution state to the other agent in a case where the value is greater than the threshold value, and determines not to propose the desired execution state thereto in a case where the value is equal to or less than the threshold value.

In this configuration as well, it is possible to perform distributed management on automatic negotiation between a plurality of agents.

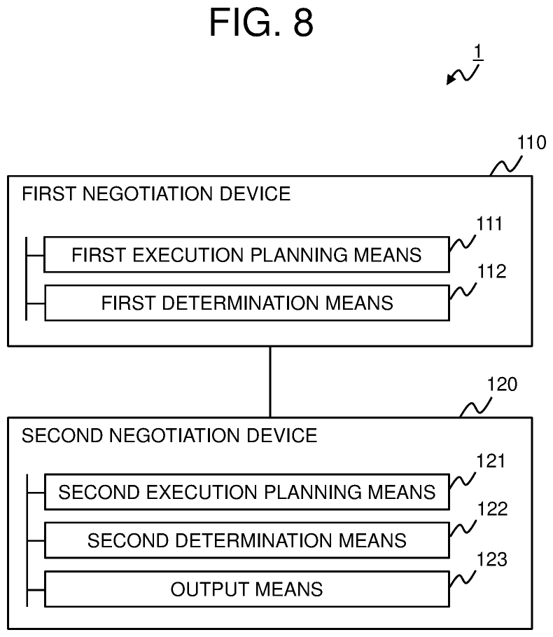

FIG. 8 is a block diagram illustrating an outline of a negotiation system according to the present invention. A negotiation system 1 (for example, the negotiation system 100) according to the present invention includes a first negotiation device 110 (for example, the first negotiation device 20) configured to determine an execution plan of a first agent based on an offer accepted from the other agent, and a second negotiation device 120 (for example, the second negotiation device 40) configured to output an offer (for example, ω) from the second agent to the first negotiation device 110.

The first negotiation device 110 includes: a first execution planning means 111 (for example, the execution planning unit 23) configured to calculate, with the offer from the second agent as a constraint condition, a first value, which is a value of an optimal execution plan up to the achievement of an objective, the optimal execution plan being planned based on a state transition (for example, the state transition function p₁(s′|s, a)) by an action taken according to a policy (for example, π_{θ1}(a|s)) of the first agent; and a first determination means 112 (for example, the determination unit 24) configured to determine, with the first value as an argument, whether or not a value calculated by a first utility function (for example, U_{θ}(ω)), which is a function defining a utility of an execution plan of the first agent in a case where the offer from the second agent is accepted, is greater than a predetermined threshold value (for example, the threshold value Uₜₕ₁).

The second negotiation device 120 includes: a second execution planning means 121 (for example, the execution planning unit 43) configured to calculate, with a desired execution state of the own agent as a constraint condition, a third value, which is a value of an optimal execution plan up to the achievement of an objective, the optimal execution plan being planned based on a state transition (for example, the state transition function p₂(s′|s, a)) by an action taken according to a policy (for example, π_{θ2}(a|s)) of the own agent; a second determination means 122 (for example, the determination unit 44) configured to determine, with the third value as an argument, whether or not a value calculated by a second utility function, which is a function defining a utility of an execution plan of the own agent determined in a case where the desired execution state is included, is greater than a predetermined threshold value (for example, the threshold value Uₜₕ₂); and an output means 123 (for example, the output unit 45) configured to output the execution state to the first negotiation device 110.

The first determination means 112 determines to accept an offer from the second agent when a calculated value is greater than a threshold value, and determines to reject the offer from the second agent when the calculated value is equal to or less than the threshold value. In addition, the second determination means 122 determines to propose a desired execution state to the other agent in a case where the calculated value is greater than a threshold value, and determines not to propose the desired execution state in a case where the calculated value is equal to or less than the threshold value.

Then, in a case where it is determined to propose an execution state, the output means 123 transmits the execution state to the first negotiation device 110, and the first execution planning means 111 calculates the first value with the execution state as a constraint condition.

In this configuration as well, it is possible to perform distributed management on automatic negotiation between a plurality of agents.

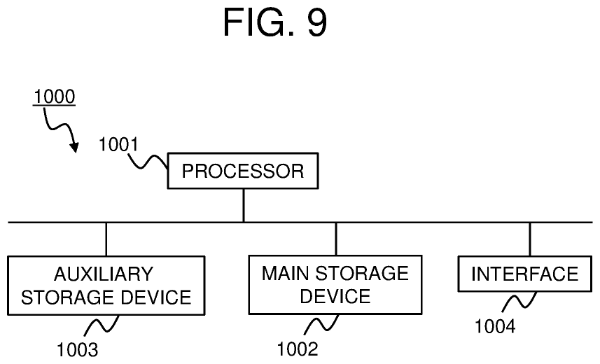

FIG. 9 is a schematic block diagram illustrating a configuration of a computer according to at least one exemplary embodiment. A computer 1000 includes a processor 1001, a main storage device 1002, an auxiliary storage device 1003, and an interface 1004.

The above-described negotiation device 80 is implemented in the computer 1000. Then, the operation of each processing unit described above is stored in the auxiliary storage device 1003 in the form of a program (negotiation program). The processor 1001 reads the program from the auxiliary storage device 1003, loads the program in the main storage device 1002, and executes the above-described processing according to the program.

It is noted that, in at least one exemplary embodiment, the auxiliary storage device 1003 is an example of a non-transitory tangible medium. Other examples of the non-transitory tangible medium include a magnetic disk, a magneto-optical disk, a compact disc read-only memory (CD-ROM), a DVD read-only memory (DVD-ROM), a semiconductor memory, and the like connected via the interface 1004. Furthermore, in a case where this program is distributed to the computer 1000 via a communication line, the computer 1000 that has received the distribution may load the program in the main storage device 1002 and execute the above-described processing.

Furthermore, the program may be provided to implement a part of the functions described above. Furthermore, the program may be a program that implements the above-described functions in combination with another program already stored in the auxiliary storage device 1003, that is, a so-called difference file (difference program).

Some or all of the exemplary embodiments may be described as the following supplementary notes, but are not limited to the following descriptions.

(Supplementary note 1) A negotiation device including:
an execution planning means configured to calculate, with an offer from another agent as a constraint condition, a first value, which is a value of an optimal execution plan up to achievement of an objective, the optimal execution plan being planned based on a state transition by an action taken according to a policy of an own agent; and
a determination means configured to determine, with the first value as an argument, whether or not a value calculated by a utility function, which is a function defining a utility of an execution plan of the own agent in a case where the offer from the other agent is accepted, is greater than a predetermined threshold value,
in which the determination means determines to accept the offer from the other agent when the value is greater than the threshold value, and determines to reject the offer from the other agent when the value is equal to or less than the threshold value.

(Supplementary note 2) The negotiation device according to supplementary note 1, further including an input means configured to accept inputs of a policy function having a function of determining an action of the own agent in a certain state, a value function having a function of calculating a value of a state of the own agent, a state transition function having a function of calculating a state to be obtained next when the action is taken in the state, and the offer from the other agent,
in which the execution planning means determines, with the accepted offer as the constraint condition, an execution plan configured to maximize a value of the value function in the case of following the policy function based on the state transition function.

(Supplementary note 3) The negotiation device according to supplementary note 2, in which the input means accepts inputs of a policy function, a value function, and a state transition function generated by reinforcement learning.

(Supplementary note 4) The negotiation device according to supplementary note 2, in which the input means accepts inputs of a policy function and a value function generated by machine learning, or a policy function and a value function defined by a predetermined method.

(Supplementary note 5) The negotiation device according to any one of supplementary notes 1 to 4, further including an output means configured to output, to the other agent, a negotiation content corresponding to a determination result of the determination means,
in which the output means outputs, to the other agent, an alternative offer together with a content indicating rejection of the offer when the determination means determines to reject the offer from the other agent.

(Supplementary note 6) The negotiation device according to any one of supplementary notes 1 to 5,
in which the execution planning means calculates a second value, which is a value of an optimal execution plan in a case where there is no offer from the other agent, and
in which the determination means calculates a value based on a utility function configured to calculate a difference between the second value and the first value as a utility, and determines whether or not the calculated value is greater than a predetermined threshold value.

(Supplementary note 7) The negotiation device according to any one of supplementary notes 1 to 6,
in which the execution planning means calculates, with an offer from the other agent including time and position information as a constraint condition, a first value, which is a value of an optimal route plan, based on a policy function and a state transition function of the own agent, and
in which the determination means determines whether or not a value calculated by a utility function defining, as a utility, a difference between the first value and a second value, which is a value of an optimal route plan in a case where the constraint condition is not considered, is greater than a predetermined threshold value.

(Supplementary note 8) A negotiation device including:
an execution planning means configured to calculate, with a desired execution state of an own agent as a constraint condition, a third value, which is a value of an optimal execution plan up to achievement of an objective, the optimal execution plan being planned based on a state transition by an action taken according to a policy of the own agent; and
a determination means configured to determine, with the third value as an argument, whether or not a value calculated by a utility function, which is a function defining a utility of an execution plan of the own agent determined when the desired execution state is included, is greater than a predetermined threshold value,
in which the determination means determines to propose the desired execution state to the other agent when the value is greater than the threshold value, and determines not to propose the desired execution state when the value is equal to or less than the threshold value.

(Supplementary note 9) A negotiation system including:
a first negotiation device configured to determine an execution plan of a first agent based on an offer accepted from another agent; and
a second negotiation device configured to output an offer from a second agent to the first negotiation device,
in which the first negotiation device includes:
a first execution planning means configured to calculate, with the offer from the second agent as a constraint condition, a first value, which is a value of an optimal execution plan up to achievement of an objective, the optimal execution plan being planned based on a state transition by an action taken according to a policy of the first agent; and
a first determination means configured to determine, with the first value as an argument, whether or not a value calculated by a first utility function, which is a function defining a utility of an execution plan of the first agent in a case where the offer from the second agent is accepted, is greater than a predetermined threshold value,
in which the second negotiation device includes:
a second execution planning means configured to calculate, with a desired execution state of an own agent as a constraint condition, a third value, which is a value of an optimal execution plan up to achievement of an objective, the optimal execution plan being planned based on a state transition by an action taken according to a policy of the own agent;
a second determination means configured to determine, with the third value as an argument, whether or not a value calculated by a second utility function, which is a function defining a utility of an execution plan of the own agent determined when the desired execution state is included, is greater than a predetermined threshold value; and
an output means configured to output the execution state to the first negotiation device,
in which the first determination means determines to accept the offer from the second agent when the value is greater than the threshold value, and determines to reject the offer from the second agent when the value is equal to or less than the threshold value,
in which the second determination means determines to propose the desired execution state to the other agent when the value is greater than the threshold value, and determines not to propose the desired execution state when the value is equal to or less than the threshold value,
in which the output means transmits the execution state to the first negotiation device when it is determined to propose the execution state, and
in which the first execution planning means calculates the first value with the execution state as a constraint condition.

(Supplementary note 10) A negotiation method including:
calculating, with an offer from another agent as a constraint condition, a first value, which is a value of an optimal execution plan up to achievement of an objective, the optimal execution plan being planned based on a state transition by an action taken according to a policy of an own agent;
determining, with the first value as an argument, whether or not a value calculated by a utility function, which is a function defining a utility of an execution plan of the own agent in a case where the offer from the other agent is accepted, is greater than a predetermined threshold value; and
determining to accept the offer from the other agent when the value is greater than the threshold value, and determining to reject the offer from the other agent when the value is equal to or less than the threshold value.

(Supplementary note 11) The negotiation method according to supplementary note 10, further including:
accepting inputs of a policy function having a function of determining an action of the own agent in a certain state, a value function having a function of calculating a value of a state of the own agent, a state transition function having a function of calculating a state to be obtained next when the action is taken in the state, and the offer from the other agent; and
determining, with the accepted offer as the constraint condition, an execution plan configured to maximize a value of the value function in the case of following the policy function based on the state transition function.

(Supplementary note 12) A negotiation method including:
calculating, with a desired execution state of an own agent as a constraint condition, a third value, which is a value of an optimal execution plan up to achievement of an objective, the optimal execution plan being planned based on a state transition by an action taken according to a policy of the own agent;
determining, with the third value as an argument, whether or not a value calculated by a utility function, which is a function defining a utility of an execution plan of the own agent determined when the desired execution state is included, is greater than a predetermined threshold value; and
determining to propose the desired execution state to another agent when the value is greater than the threshold value, and determining not to propose the desired execution state when the value is equal to or less than the threshold value.

(Supplementary note 13) A program storage medium having a negotiation program stored therein and configured to cause a computer to:
execute an execution planning process of calculating, with an offer from another agent as a constraint condition, a first value, which is a value of an optimal execution plan up to achievement of an objective, the optimal execution plan being planned based on a state transition by an action taken according to a policy of an own agent, and a determination process of determining, with the first value as an argument, whether or not a value calculated by a utility function, which is a function defining a utility of an execution plan of the own agent in a case where the offer from the other agent is accepted, is greater than a predetermined threshold value; and
determine, by the determination process, to accept the offer from the other agent when the value is greater than the threshold value, and determine, by the determination process, to reject the offer from the other agent when the value is equal to or less than the threshold value.

(Supplementary note 14) The program storage medium according to supplementary note 13, having the negotiation program stored therein and configured to cause the computer to:
execute an input process of accepting inputs of a policy function having a function of determining an action of the own agent in a certain state, a value function having a function of calculating a value of a state of the own agent, a state transition function having a function of calculating a state to be obtained next when the action is taken in the state, and the offer from the other agent; and
determine, by the execution planning process, an execution plan configured to maximize a value of the value function in the case of following the policy function based on the state transition function with the accepted offer as the constraint condition.

(Supplementary note 15) A program storage medium having a negotiation program stored therein and configured to cause a computer to:
execute an execution planning process of calculating, with a desired execution state of an own agent as a constraint condition, a third value, which is a value of an optimal execution plan up to achievement of an objective, the optimal execution plan being planned based on a state transition by an action taken according to a policy of the own agent, and a determination process of determining, with the third value as an argument, whether or not a value calculated by a utility function, which is a function defining a utility of an execution plan of the own agent determined when the desired execution state is included, is greater than a predetermined threshold value; and
determine, by the determination process, to propose the desired execution state to another agent when the value is greater than the threshold value, and determine, by the determination process, not to propose the desired execution state when the value is equal to or less than the threshold value.

(Supplementary note 16) A negotiation program configured to cause a computer to:
execute an execution planning process of calculating, with an offer from another agent as a constraint condition, a first value, which is a value of an optimal execution plan up to achievement of an objective, the optimal execution plan being planned based on a state transition by an action taken according to a policy of an own agent, and a determination process of determining, with the first value as an argument, whether or not a value calculated by a utility function, which is a function defining a utility of an execution plan of the own agent in a case where the offer from the other agent is accepted, is greater than a predetermined threshold value; and
determine, by the determination process, to accept the offer from the other agent when the value is greater than the threshold value, and determine, by the determination process, to reject the offer from the other agent when the value is equal to or less than the threshold value.

(Supplementary note 17) The negotiation program according to supplementary note 16, configured to cause the computer to:
execute an input process of accepting inputs of a policy function having a function of determining an action of the own agent in a certain state, a value function having a function of calculating a value of a state of the own agent, a state transition function having a function of calculating a state to be obtained next when the action is taken in the state, and the offer from the other agent; and
determine, by the execution planning process, an execution plan configured to maximize a value of the value function in the case of following the policy function based on the state transition function with the accepted offer as the constraint condition.

(Supplementary note 18) A negotiation program configured to cause a computer to:
execute an execution planning process of calculating, with a desired execution state of an own agent as a constraint condition, a third value, which is a value of an optimal execution plan up to achievement of an objective, the optimal execution plan being planned based on a state transition by an action taken according to a policy of the own agent, and a determination process of determining, with the third value as an argument, whether or not a value calculated by a utility function, which is a function defining a utility of an execution plan of the own agent determined when the desired execution state is included, is greater than a predetermined threshold value; and
determine, by the determination process, to propose the desired execution state to another agent when the value is greater than the threshold value, and determine, by the determination process, not to propose the desired execution state when the value is equal to or less than the threshold value.

Although the present invention has been described above with reference to the exemplary embodiments, the present invention is not limited to the above-described exemplary embodiments. Various modifications that can be understood by those skilled in the art can be made to the configuration and details of the present invention within the scope of the present invention.

### REFERENCE SIGNS LIST

10 First learning device
20 First negotiation device
21, 41 Storage unit
22, 42 Input unit
23, 43 Execution planning unit
24, 44 Determination unit
25, 45 Output unit
30 Second learning device
40 Second negotiation device
51 First agent
52 Second agent
61, 62 Route plan
100 Negotiation system

What is claimed is:

1. A negotiation device comprising:
a memory storing instructions; and
one or more processors configured to execute the instructions to:
calculate, with an offer from another agent as a constraint condition, a first value, which is a value of an optimal execution plan up to achievement of an objective, the optimal execution plan being planned based on a state transition by an action taken according to a policy of an own agent;
determine, with the first value as an argument, whether or not a value calculated by a utility function, which is a function defining a utility of an execution plan of the own agent in a case where the offer from the other agent is accepted, is greater than a predetermined threshold value; and
determine to accept the offer from the other agent when the value is greater than the threshold value, and determine to reject the offer from the other agent when the value is equal to or less than the threshold value.

2. The negotiation device according to claim 1, wherein the processor is configured to execute the instructions to:
accept inputs of a policy function having a function of determining an action of the own agent in a certain state, a value function having a function of calculating a value of a state of the own agent, a state transition function having a function of calculating a state to be obtained next when the action is taken in the state, and the offer from the other agent; and
determine, with the accepted offer as the constraint condition, an execution plan configured to maximize a value of the value function in the case of following the policy function based on the state transition function.

3. The negotiation device according to claim 2, wherein the processor is configured to execute the instructions to accept inputs of a policy function, a value function, and a state transition function generated by reinforcement learning.

4. The negotiation device according to claim 2, wherein the processor is configured to execute the instructions to accept inputs of a policy function and a value function generated by machine learning, or a policy function and a value function defined by a predetermined method.

5. The negotiation device according to claim 1, wherein the processor is configured to execute the instructions to output, to the other agent, a negotiation content corresponding to a determination result; and
output, to the other agent, an alternative offer together with a content indicating rejection of the offer when determined to reject the offer from the other agent.

6. The negotiation device according to claim 1, wherein the processor is configured to execute the instructions to:
calculate a second value, which is a value of an optimal execution plan in a case where there is no offer from the other agent; and
calculate a value based on a utility function configured to calculate a difference between the second value and the first value as a utility, and whether or not the calculated value is greater than a predetermined threshold value.

7. The negotiation device according to claim 1, wherein the processor is configured to execute the instructions to:
calculate, with an offer from the other agent including time and position information as a constraint condition, a first value, which is a value of an optimal route plan, based on a policy function and a state transition function of the own agent; and
determine whether or not a value calculated by a utility function defining, as a utility, a difference between the first value and a second value, which is a value of an optimal route plan in a case where the constraint condition is not considered, is greater than a predetermined threshold value.

8. A negotiation device comprising:
a memory storing instructions; and
one or more processors configured to execute the instructions to:
calculate, with a desired execution state of an own agent as a constraint condition, a third value, which is a value of an optimal execution plan up to achievement of an objective, the optimal execution plan being planned based on a state transition by an action taken according to a policy of the own agent;
determine, with the third value as an argument, whether or not a value calculated by a utility function, which is a function defining a utility of an execution plan of the own agent determined when the desired execution state is included, is greater than a predetermined threshold value; and
determine to propose the desired execution state to another agent when the value is greater than the threshold value, and determine not to propose the desired execution state when the value is equal to or less than the threshold value.

9. A negotiation system comprising:
a first negotiation device configured to determine an execution plan of a first agent based on an offer accepted from another agent; and
a second negotiation device configured to output an offer from a second agent to the first negotiation device,
wherein the first negotiation device includes:
a first execution planning means configured to calculate, with the offer from the second agent as a constraint condition, a first value, which is a value of an optimal execution plan up to achievement of an objective, the optimal execution plan being planned based on a state transition by an action taken according to a policy of the first agent; and
a first determination means configured to determine, with the first value as an argument, whether or not a value calculated by a first utility function, which is a function defining a utility of an execution plan of the first agent in a case where the offer from the second agent is accepted, is greater than a predetermined threshold value,
wherein the second negotiation device includes:
a second execution planning means configured to calculate, with a desired execution state of an own agent as a constraint condition, a third value, which is a value of an optimal execution plan up to achievement of an objective, the optimal execution plan being planned based on a state transition by an action taken according to a policy of the own agent;
a second determination means configured to determine, with the third value as an argument, whether or not a value calculated by a second utility function, which is a function defining a utility of an execution plan of the own agent determined when the desired execution state is included, is greater than a predetermined threshold value; and
an output means configured to output the execution state to the first negotiation device,
wherein the first determination means determines to accept the offer from the second agent when the value is greater than the threshold value, and determines to reject the offer from the second agent when the value is equal to or less than the threshold value,
wherein the second determination means determines to propose the desired execution state to the other agent when the value is greater than the threshold value, and determines not to propose the desired execution state when the value is equal to or less than the threshold value,
wherein the output means transmits the execution state to the first negotiation device when it is determined to propose the execution state, and
wherein the first execution planning means calculates the first value with the execution state as a constraint condition.

10.-15. (canceled)
